(19) United States
(12) Patent Application Publication
(10) Pub. No.: US 2026/0175914 A1
(43) Pub. Date: Jun. 25, 2026

(54) CONTROL DEVICE, CONTROL METHOD, AND STORAGE MEDIUM

(71) Applicant: HONDA MOTOR CO., LTD., Tokyo (JP)

(72) Inventors: Daisuke ISHIZUKA, Tokyo (JP); Yuki HARA, Tokyo (JP); Hideki NAGATOMO, Tokyo (JP)

(73) Assignee: HONDA MOTOR CO., LTD., Tokyo (JP)

(21) Appl. No.: 19/355,418

(22) Filed: Oct. 10, 2025

(30) Foreign Application Priority Data
Oct. 11, 2024 (JP) 2024-178555

(51) Int. Cl. B62D 15/02

(52) U.S. Cl. CPC B62D 15/021; B62D 15/025

(57) ABSTRACT

A control device for controlling a vehicle, includes: a travel control unit configured to perform, based on travel history information including travel route information indicating a travel route during first travel to a current position of the vehicle, second travel for causing the vehicle to move along the travel route from the current position to a movement completion point on the travel route, the travel history information being stored in a storage unit; and a setting unit configured to set, before the second travel, any point on the travel route designated by a user as the movement completion point. The travel control unit performs the second travel to the movement completion point set by the setting unit, and ends the second travel in response to the vehicle reaching the movement completion point.

This application is based upon and claims the benefit of priority from prior Japanese patent application No. 2024-178555, filed on Oct. 11, 2024, the entire contents of which are incorporated herein by reference.

### TECHNICAL FIELD

The present disclosure relates to a control device, a control method, and a storage medium storing a control program.

### BACKGROUND ART

In recent years, improvements in traffic safety have been required to enable inclusion, safety, toughness, and sustainability of urban and human residents. From a viewpoint of improving the traffic safety, for example, developments of a driving assistance technique and an autonomous driving technique for vehicles have been advanced.

As an example of the driving assistance technique, JP2018-203214A discloses a technique in which a peripheral image generated based on an imaging result of an imaging unit provided in a vehicle is displayed on a touch panel, a first symbol representing a parking region where the vehicle can be parked is displayed on the peripheral image, and when a position corresponding to the first symbol is touched, parking in the parking region represented by the first symbol is assisted.

### SUMMARY OF INVENTION

There is room for improvement from a viewpoint of improving convenience of a user.

Aspects of the present disclosure relate to a control device, a control method, and a storage medium storing a control program capable of improving convenience of a user.

According to an aspect of the present disclosure, there is provided a control device for controlling a vehicle, including:
a travel control unit configured to perform, based on travel history information including travel route information indicating a travel route during first travel to a current position of the vehicle, second travel for causing the vehicle to move along the travel route from the current position to a movement completion point on the travel route, the travel history information being stored in a storage unit; and
a setting unit configured to set, before the second travel, any point on the travel route designated by a user as the movement completion point, in which
the travel control unit performs the second travel to the movement completion point set by the setting unit, and ends the second travel in response to the vehicle reaching the movement completion point.

According to another aspect of the present disclosure, there is provided a control method including:
performing, by a computer that controls a vehicle, based on travel history information including travel route information indicating a travel route during first travel to a current position of the vehicle, second travel for causing the vehicle to move along the travel route from the current position to a movement completion point on the travel route, the travel history information being stored in a storage unit; and
setting, by the computer, before the second travel, any point on the travel route designated by a user as the movement completion point, in which
in the processing of performing the second travel, the second travel to the set movement completion point is performed, and the second travel is ended in response to the vehicle reaching the movement completion point.

According to another aspect of the present disclosure, there is provided a non-transitory computer-readable storage medium storing a control program causing a computer, that controls a vehicle, to execute a process, the process including:
performing, based on travel history information including travel route information indicating a travel route during first travel to a current position of the vehicle, second travel for causing the vehicle to move along the travel route from the current position to a movement completion point on the travel route, the travel history information being stored in a storage unit; and
setting, before the second travel, any point on the travel route designated by a user as the movement completion point, in which
in the processing of performing the second travel, the second travel to the set movement completion point is performed, and the second travel is ended in response to the vehicle reaching the movement completion point.

According to aspects of the present disclosure, it is possible to provide a control device, a control method, and a storage medium storing a control program capable of improving convenience of a user.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 including a control device 30 that is an embodiment of a control device of the present disclosure;

FIG. 2 is a diagram showing an example of travel history information 200 stored in a storage unit 35;

FIG. 3 is a diagram (Part 1) showing an example of an overhead image BI displayed by the control device 30;

FIG. 4 is a diagram (Part 2) showing an example of the overhead image BI displayed by the control device 30;

FIG. 5 is a diagram showing an example of reverse assist travel performed by the control device 30;

FIG. 6 is a flowchart showing an example of processing performed by the control device 30; and

FIG. 7 is a diagram showing an example of changing a display range of the overhead image BI by the control device 30 according to a modification.

### DESCRIPTION OF EMBODIMENTS

Hereinafter, an embodiment of a control device, a control method, and a storage medium storing a control program of the present disclosure will be described with reference to the drawings. The drawings are viewed in directions of reference numerals. The following embodiment does not limit the present disclosure, and not all of elements described in the following embodiment are necessary to the present disclosure. Hereinafter, the same or similar elements are denoted by the same or similar reference signs, and the description thereof may be omitted or simplified.

### 1. Vehicle

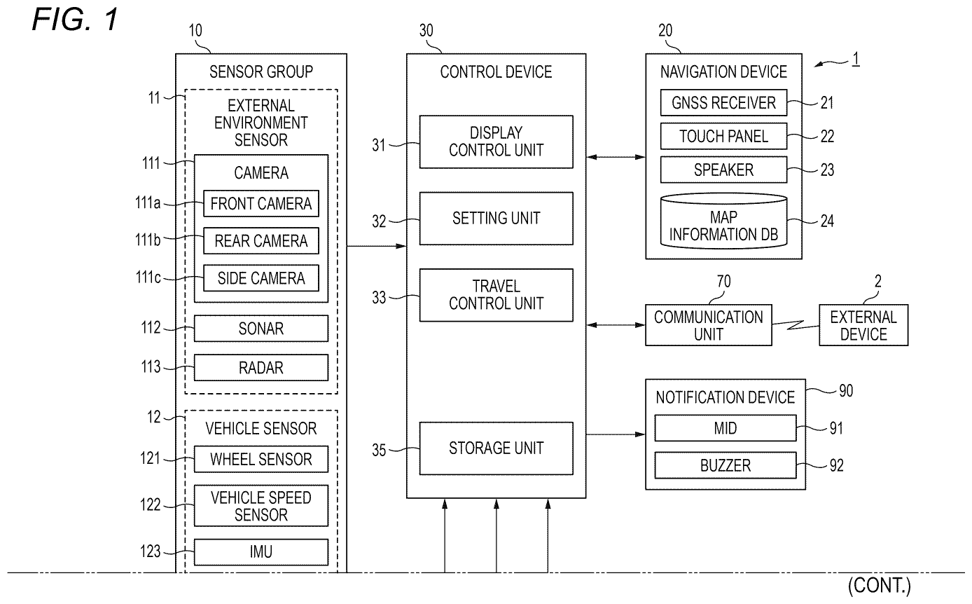

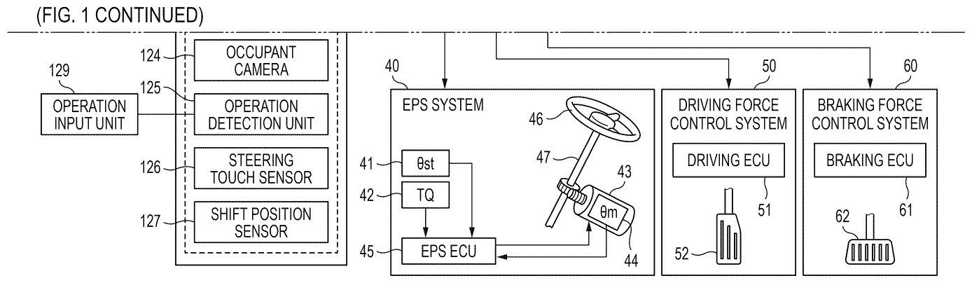

A vehicle 1 according to the present embodiment shown in FIG. 1 is an automobile including a drive source (not shown), and wheels (not shown) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 includes a sensor group 10, a navigation device 20, a control device 30, an electric power steering (EPS) system 40, a driving force control system 50, a braking force control system 60, a communication unit 70, and a notification device 90.

The sensor group 10 includes an external environment sensor 11 that acquires external environment information for recognizing a periphery (in other words, surroundings) of the vehicle 1, and a vehicle sensor 12 that acquires information on the vehicle 1 (hereinafter, also referred to as “vehicle information”). The information acquired by each sensor in the sensor group 10 is output to the control device 30, and is used for control of the vehicle 1 (hereinafter, also referred to as “vehicle control”) performed by the control device 30.

The external environment sensor 11 includes, for example, cameras 111, a sonar 112, and a radar 113. The cameras 111 image the periphery of the vehicle 1 including a front side of the vehicle 1, and output image data of an obtained peripheral image to the control device 30. Such image data is an example of the external environment information. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on an upper portion of a front window or a front grille (not shown) of the vehicle 1, and images a scene in front of the vehicle 1. The rear camera 111b is provided, for example, near a license plate (in other words, an automobile registration number mark) attached to a rear portion of the vehicle 1, and images a scene behind the vehicle 1. The side cameras 111c are provided, for example, on left and right side mirrors (not shown), and image scenes on lateral sides (that is, left and right sides) of the vehicle 1.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the external environment information.

The radar 113 emits radio waves to the periphery of the vehicle 1 including the front side of the vehicle 1, and receives reflected waves from an object present in the periphery of the vehicle 1, thereby detecting a distance to the object, a direction of the object, and the like. As the radar 113, for example, a millimeter wave radar can be adopted. The detection result of the radar 113 is another example of the external environment information.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed 15 sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a 20 displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity 30 of the vehicle 1 in a predetermined direction.

The occupant camera 124 is a digital camera that images an interior of the vehicle 1 and outputs image data of an obtained interior image to the control device 30. For example, the occupant camera 124 can be a so-called “driver monitor camera” provided to be able to image a head of an occupant seated in a driver seat of the vehicle 1 (for example, a user driving the vehicle 1, hereinafter simply referred to as “user”) from the front. As the occupant camera 124, a digital camera using an imaging element such as the CCD or the CMOS can be adopted, similarly to the camera 111.

The operation detection unit 125 detects an operation performed by using an operation input unit 129 that is operable by the user. The operation input unit 129 may include, for example, a switch or a button that receives a reverse assist operation request to be described later.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not shown) provided in the vehicle 1 is any one of “P (parking)”, “R (reverse)”, “N (neutral)”, and “D (drive)”. When the vehicle 1 may take another shift position (for example, “B (brake)”) other than the “P”, the “R”, the “N”, and the “D”, the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing roads based on a combination of nodes and links connecting the nodes (also referred to as “paths”). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a travel direction, a road type, and the like is set.

The GNSS receiver 21 specifies a current position of the vehicle 1 (for example, a latitude and a longitude of a location where the vehicle 1 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output sound to the occupant of the vehicle 1 including the user. The touch panel 22 is an example of a notification unit capable of issuing a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 may output predetermined information (for example, information indicating an operation received via the touch panel 22) to the control device 30. For example, the navigation device 20 may cause, according to an instruction from the control device 30, the touch panel 22 to display a button for receiving a reverse assist operation request to be described later.

The control device 30 is an example of the control device according to the present disclosure and is a computer that integrally controls the entire vehicle 1. For example, the control device 30 includes, for example, a processor (not shown) that performs various calculations, a storage unit 35 including a non-transitory storage medium that stores various types of information (for example, programs and various types of data), and an input and output unit (not shown) as an interface that controls input and output of data between the inside and the outside of the control device 30.

The control device 30 includes, for example, a display control unit 31, a setting unit 32, and a travel control unit 33 as functional units implemented by the processor executing the programs stored in the storage unit 35. These functional units will be described later, and thus the description thereof will be omitted here. For example, the control device 30 is implemented by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, the driving ECU 51 controls power output from the drive source of the vehicle 1, based on an operation on an accelerator pedal 52 provided in the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under control of the control device 30. That is, the control device 30 may communicate with the external device 2 via the communication unit 70. Examples of the external device 2 include a terminal device (for example, a smartphone) of the user and a server device managed by a manufacturer of the vehicle 1. For example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. The MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. The buzzer 92 may be integrated with the speaker 23 described above.

### 2. Control Device

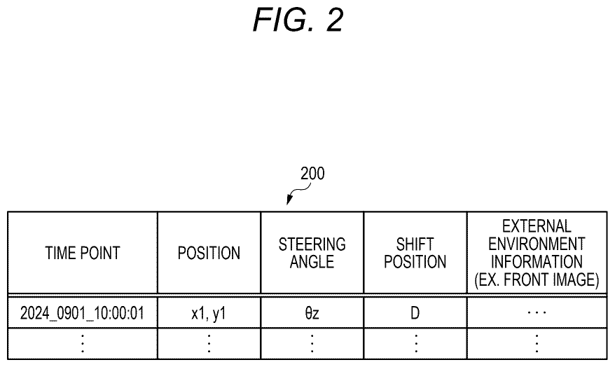

Next, the control device 30 will be described in more detail. First, an example of the information stored in the storage unit 35 will be described with reference to FIG. 2.

### 2-1. Travel History Information Stored in Storage Unit

The storage unit 35 stores, for example, travel history information 200 shown in FIG. 2. As shown in FIG. 2, the travel history information 200 includes, for example, information indicating the position of the vehicle 1, the steering angle θst, and the shift position (for example, “P”, “R”, “N”, or “D”) at each time point. The information indicating the steering angle θst in the travel history information 200 is an example of “control information” in the present disclosure. The information indicating the shift position in the travel history information 200 is another example of the “control information” in the present disclosure.

For example, when the vehicle 1 is manually driven, the control device 30 acquires information indicating the latitude and longitude of the point where the vehicle 1 is located, which is specified by the navigation device 20 (for example, the GNSS receiver 21), the information indicating the steering angle θst detected by the EPS system 40 (for example, the steering angle sensor 41), and the information indicating the shift position detected by the shift position sensor 127, at a predetermined cycle (for example, every 10 [ms]). Then, the control device 30 stores the acquired information indicating these into the storage unit 35 in association with information indicating a time point at the time of acquisition. Accordingly, the travel history information 200 is stored which includes information in which the information indicating the position of the vehicle 1, the information indicating the steering angle θst, and the information indicating the shift position at the same time point during travel based on manual driving are associated with one another.

The travel history information 200 may include other information. For example, as shown in FIG. 2, the travel history information 200 may further include the external environment information at each time point. As an example, the travel history information 200 may include information indicating a front image at each time point as the external environment information. In this case, when the vehicle 1 is manually driven, the control device 30 may acquire the information indicating the latitude and longitude of the point where the vehicle 1 is located, which is specified by the navigation device 20, the information indicating the steering angle θst detected by the EPS system 40, the information indicating the shift position detected by the shift position sensor 127, and the information indicating the front image captured by the front camera 111a at a predetermined cycle, and store the acquired information indicating these into the storage unit 35 in association with the information indicating the time point at the time of acquisition. In this way, the travel history information 200 including information in which the information indicating the position of the vehicle 1, the information indicating the steering angle θst, the information indicating the shift position, and the external environment information at the same time point during travel based on manual driving are associated with each other can be stored into the storage unit 35.

The travel history information 200 including the information indicating the position of the vehicle 1 at each time point can also be said to be information indicating a temporal transition in the position of the vehicle 1. The temporal transition in the position of the vehicle 1 represents a travel route on which the vehicle 1 has traveled. Therefore, the travel history information 200 includes travel route information indicating a travel route along which the vehicle 1 has traveled. As described above, when the travel history information 200 is stored based on the fact that the vehicle 1 is traveling by manual driving, the travel history information 200 includes the travel route information indicating a travel route (hereinafter also referred to as “travel route Rt”) along which the vehicle 1 has traveled based on the manual driving.

In the travel history information 200, the information indicating the steering angle θst associated with the information indicating each position of the vehicle 1 represents the steering angle θst when the vehicle 1 is at the position, that is, an operation state of the steering 46. Therefore, the travel history information 200 may represent the operation state of the steering 46 when the vehicle 1 travels on the travel route Rt.

Further, in the travel history information 200, the information indicating the shift position associated with the information indicating each position of the vehicle 1 represents the shift position when the vehicle 1 is at the position, that is, an operation state of the shift lever. Therefore, the travel history information 200 may represent the operation state of the shift lever when the vehicle 1 travels on the travel route Rt.

In the present embodiment, the control device 30 stores, into the storage unit 35, the travel history information 200 indicating the travel route Rt of a predetermined distance (for example, 200 [m]) immediately before the vehicle 1 reaches the current position. In other words, the control device 30 deletes, from the storage unit 35, information on a portion of the travel route that is outside the predetermined distance due to the travel of the vehicle 1. Accordingly, a storage area of the storage unit 35 required to store the travel history information 200 can be reduced.

In the present embodiment, the control device 30 includes the storage unit 35 that stores the travel history information 200, but the present disclosure is not limited thereto. That is, the storage unit 35 may be provided outside the control device 30 in a state of being accessible by the control device 30.

### 2-2. Processing Performed by Control Device

The control device 30 is configured to perform reverse assist by a function of the travel control unit 33 to be described later. Here, the reverse assist is a vehicle control for moving (for example, reversing) the vehicle 1 along the travel route Rt from the current position of the vehicle 1 to the movement completion point EP on the travel route Rt indicated by the travel route information contained in the travel history information 200. The reverse assist may be used, for example, in a situation where the vehicle 1 is forced to move backward because the vehicle 1 enters a dead end or cannot pass by an oncoming vehicle.

Hereinafter, travel of the vehicle 1 based on the manual driving of the user is also referred to as “manual driving travel”, and travel of the vehicle 1 based on the reverse assist is also referred to as “reverse assist travel”. The manual driving travel is an example of first travel in the present disclosure, and the reverse assist travel is an example of second travel in the present disclosure.

During the manual driving travel, the user steers the vehicle 1 using the steering 46. Meanwhile, during the reverse assist travel, the control device 30 automatically controls the steering of the vehicle 1. Therefore, by using the reverse assist, the user can return the vehicle 1 to the previous movement completion point EP without operating the steering 46 by himself/herself. Accordingly, time and effort for the user to return the vehicle 1 to the movement completion point EP can be reduced, and the convenience of the user can be improved.

For example, the control device 30 performs the reverse assist in response to receiving a predetermined reverse assist operation request (hereinafter, also referred to as “RA operation request”). The RA operation request can be, for example, an operation on a predetermined operator provided in the operation input unit 129 or an operation of tapping a predetermined button displayed on the touch panel 22. The control device 30 may stop the reverse assist travel when a predetermined stop operation is performed during the reverse assist travel. Similarly to the RA operation request, the stop operation can be, for example, an operation on a predetermined operator provided in the operation input unit 129 or an operation of tapping a predetermined button displayed on the touch panel 22.

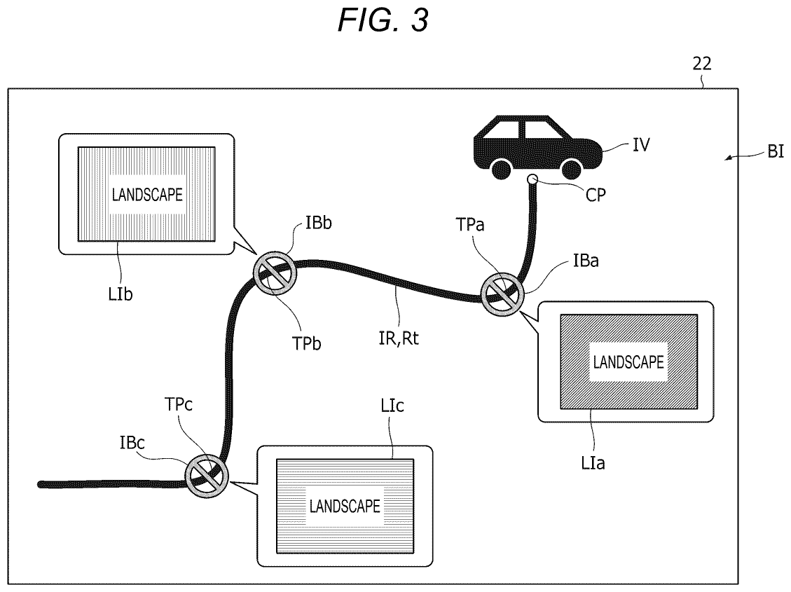

As shown in FIG. 3, before the reverse assist travel, the display control unit 31 of the control device 30 displays, on the touch panel 22, an overhead image BI in which the travel route Rt is drawn from an overhead viewpoint. As an example, when the control device 30 receives the RA operation request, the display control unit 31 displays the overhead image BI on the touch panel 22 while referring to the travel history information 200 stored in the storage unit 35. When displaying the overhead image BI, the display control unit 31 may further use the information in the map information database 24 stored in the navigation device 20.

As shown in FIG. 3, the overhead image BI includes, for example, a vehicle icon IV representing a current position CP of the vehicle 1 and a travel route image IR representing the travel route Rt along which the vehicle 1 has traveled to the current position CP.

Further, the display control unit 31 may display a predetermined icon at or around a position corresponding to a predetermined point on the travel route Rt in the overhead image BI. In other words, the display control unit 31 may display a predetermined icon corresponding to a predetermined point on the travel route Rt in the overhead image BI.

Here, the predetermined point can be, for example, a point having a predetermined attribute (hereinafter, also referred to as “feature point”) such as an inflection point with a predetermined angle (for example, 90 degrees) or more on the travel route Rt (hereinafter, also simply referred to as “inflection point”), a place where a road width changes, a place where the road width is a certain value or more, an intersection entrance, a dead end entrance, or a sign installation place. Such a feature point is often desired by the user as the movement completion point EP of the reverse assist. Such a feature point can be detected, for example, based on the travel history information 200 stored in the storage unit 35. Further, the map information database 24 may be used to detect the feature point.

In the example shown in FIG. 3, feature point icons IBa, IBb, and IBc representing the feature points are displayed corresponding to feature points TPa, TPb, and TPc that are inflection points on the travel route Rt in the overhead image BI, respectively. Each of the feature point icons IBa, IBb, and IBc is an example of a second icon in the present disclosure.

Further, the display control unit 31 may display, at or around a position corresponding to a predetermined point (for example, a feature point) on the travel route Rt in the overhead image BI, external environment information corresponding to the point. As an example, the display control unit 31 may display, at or around a position corresponding to the feature point on the travel route Rt in the overhead image BI, the front image of the vehicle 1 captured by the front camera 111a at the feature point.

In the example shown in FIG. 3, a landscape image LIa, which is a front image captured at the feature point TPa, is displayed corresponding to the feature point TPa. The landscape image LIa can be displayed based on, for example, information indicating a front image corresponding to the feature point TPa in the travel history information 200 stored in the storage unit 35.

Further, in the example shown in FIG. 3, a landscape image LIb, which is a front image captured at the feature point TPb, is displayed corresponding to the feature point TPb. Further, in the example shown in FIG. 3, a landscape image LIc, which is a front image captured at the feature point TPc, is displayed corresponding to the feature point TPc. By displaying such landscape images LIa, LIb, and LIc, the user can easily grasp what kinds of points the feature points TPa, TPb, and TPc are.

Further, the display control unit 31 may display the overhead image BI including an image representing an object (for example, a building or an obstacle) or the like recognized by the control device 30 based on the external environment information obtained by the external environment sensor 11 when the vehicle 1 is traveling on the travel route Rt.

The setting unit 32 sets any point on the travel route Rt designated by the user as the movement completion point EP of the reverse assist. In the present embodiment, the movement completion point EP is designated by the user using the overhead image BI displayed on the touch panel 22. Accordingly, the user can intuitively and easily designate a desired point on the travel route Rt as the movement completion point EP.

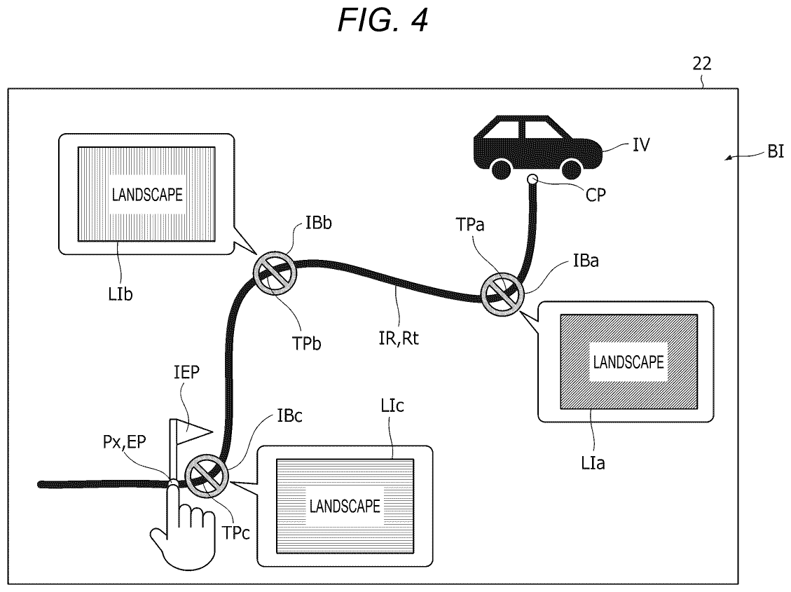

For example, as shown in FIG. 4, it is assumed that a point Px on the travel route Rt in the overhead image BI displayed on the touch panel 22 is tapped. In this case, the setting unit 32 sets the point Px as the movement completion point EP.

Further, for example, when the movement completion point EP is not designated by the user within a predetermined time (that is, a timeout occurs) or when there is an operation of instructing to set a predetermined default point as the movement completion point EP, the setting unit 32 may set the default point as the movement completion point EP. Here, the default point can be, for example, a point returned from the current position of the vehicle 1 along the travel route Rt by a maximum distance (for example, 200 [m]) of the travel route Rt indicated by the travel history information 200. However, the present disclosure is not limited thereto, and the default point may be, for example, a point returned from the current position of the vehicle 1 along the travel route Rt by any distance (for example, 100 [m]) designated in advance by the user. Further, for example, when an operation of canceling the movement completion point EP designated by the user is performed during the reverse assist travel, the setting unit 32 may reset the movement completion point EP to the default point.

Further, in order to notify the user that the movement completion point EP is set, the display control unit 31 may display a predetermined icon at or around a position corresponding to the movement completion point EP in the overhead image BI, in response to the movement completion point EP being set by the setting unit 32. In other words, the display control unit 31 may display a predetermined icon corresponding to the movement completion point EP in the overhead image BI. In the example shown in FIG. 4, a movement completion point icon IEP representing the movement completion point EP is displayed corresponding to the movement completion point EP in the overhead image BI. The movement completion point icon IEP is an example of a first icon in the present disclosure.

Further, in response to the movement completion point EP being set by the setting unit 32, the display control unit 31 may display the external environment information corresponding to the movement completion point EP at or around the position corresponding to the movement completion point EP in the overhead image BI. As an example, the display control unit 31 may display, at or around the position corresponding to the movement completion point EP in the overhead image BI, a front image of the vehicle 1 captured by the front camera 111a at the point Px set as the movement completion point EP. In this way, the user can easily grasp what kind of point the movement completion point EP is. Such a front image can be displayed based on, for example, information, that indicates the front image corresponding to the point Px, in the travel history information 200 stored in the storage unit 35.

When the movement completion point EP is set by the setting unit 32, the travel control unit 33 performs the reverse assist travel to the movement completion point EP. Specifically, based on the travel history information 200 stored in the storage unit 35, the travel control unit 33 causes the vehicle 1 to move (for example, reverse) from the current position of the vehicle 1 to the movement completion point EP set by the setting unit 32 along the travel route Rt. Then, the travel control unit 33 ends the reverse assist travel in response to the vehicle 1 reaching the movement completion point EP set by the setting unit 32.

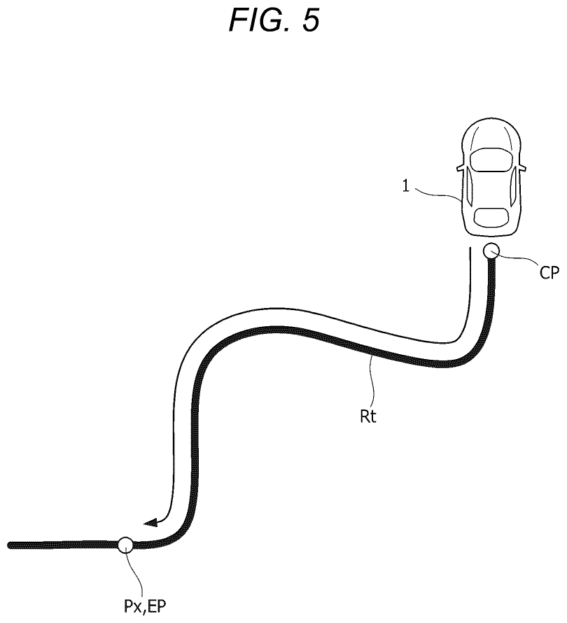

For example, as shown in FIG. 4, it is assumed that the point Px is set as the movement completion point EP. In this case, as shown in FIG. 5, the travel control unit 33 causes the vehicle 1 to travel (for example, reverse) along the travel route Rt from the current position CP of the vehicle 1 immediately before the reverse assist travel to the point Px that is the movement completion point EP. At this time, the travel control unit 33 may control the steering of the vehicle 1 via the EPS system 40 such that the vehicle 1 travels while tracing a portion of the travel route Rt from the current position CP to the point Px. At this time, the travel control unit 33 may control the driving force of the vehicle 1 via the driving force control system 50, or may control the braking force of the vehicle 1 via the braking force control system 60. However, the present disclosure is not limited thereto, and the driving force or the braking force of the vehicle 1 may be adjusted by the user via the accelerator pedal 52 or the brake pedal 62, for example. In other words, the control device 30 may control only the steering of the vehicle 1.

As described above, the travel history information 200 may include the information indicating the steering angle θst when the vehicle 1 travels on the travel route Rt to the current position CP. Therefore, during the reverse assist travel, the travel control unit 33 may control the steering of the vehicle 1 while referring to the information indicating the steering angle θst contained in the travel history information 200. In this way, since it is not necessary to re-derive, during the reverse assist travel, the steering angle θst required by the vehicle 1 to travel along the travel route Rt, the reverse assist travel can be appropriately performed by simple processing.

The travel control unit 33 may start the reverse assist travel in response to a predetermined start operation performed by the user after the movement completion point EP is set by the setting unit 32. In this way, it is possible to prevent the reverse assist travel from being started at a timing not intended by the user.

During the reverse assist travel, the display control unit 31 preferably displays the overhead image BI in which the vehicle icon IV moves on the travel route Rt toward the movement completion point EP based on a position of the vehicle 1 at that time. In this way, the user can easily grasp where the vehicle 1 is traveling on the travel route Rt from the overhead image BI displayed during the reverse assist travel.

### 2-3. Processing Performed by Control Device

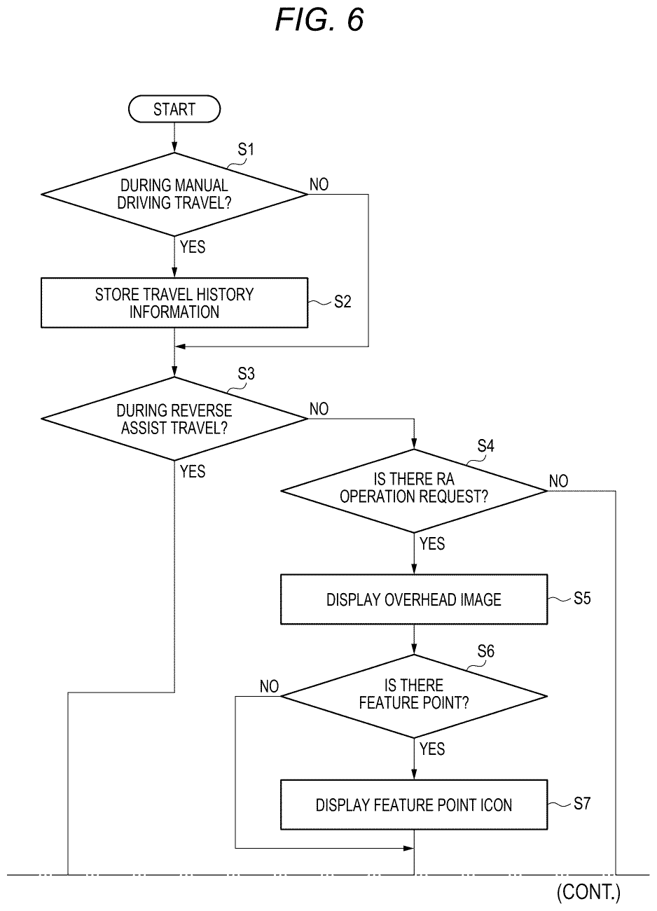

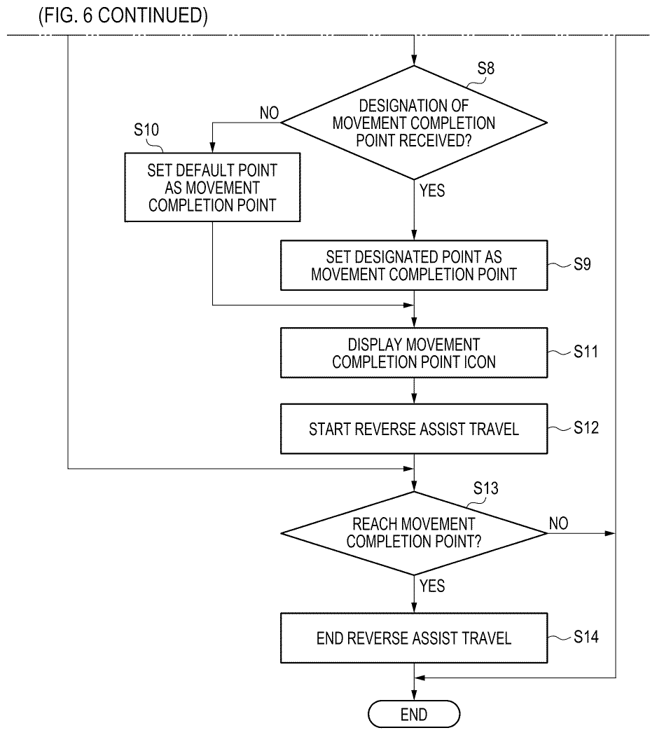

Next, an example of processing performed by the control device 30 will be described with reference to FIG. 6. For example, when an ignition power supply of the vehicle 1 is turned on, the control device 30 repeatedly performs a series of processing shown in FIG. 6 at a predetermined cycle.

As shown in FIG. 6, for example, the control device 30 first determines whether the vehicle 1 is in the manual driving travel (step S1). When it is determined that the manual driving travel is not being performed (step S1: NO), the control device 30 proceeds to processing in step S3. When it is determined that the manual driving travel is being performed (step S1: YES), the control device 30 stores the travel history information 200 in the storage unit 35 based on the information obtained by the sensor group 10 or the like (step S2), and proceeds to the processing in step S3.

Next, the control device 30 determines whether the vehicle 1 is in the reverse assist travel (step S3). When it is determined that the reverse assist travel is being performed (step S3: YES), the control device 30 proceeds to processing in step S13. When it is determined that the reverse assist travel is not being performed (step S3: NO), the control device 30 determines whether there is an RA operation request (step S4).

When it is determined that there is no RA operation request (step S4: NO), the control device 30 ends the series of processing. On the other hand, when it is determined that there is an RA operation request (step S4: YES), the control device 30 displays the overhead image BI shown in FIG. 3 on the touch panel 22, based on the travel history information 200 or the like stored in the storage unit 35 (step S5).

Then, the control device 30 determines whether there is the above-described feature point on the travel route Rt in the overhead image BI (step S6). When it is determined that there is no feature point (step S6: NO), the control device 30 proceeds to processing in step S8. As another example, when it is determined that there is no feature point, the control device 30 may proceed to processing in step S10 and set the default point as the movement completion point EP.

When it is determined that there is the feature point (step S6: YES), the control device 30 displays the feature point icon corresponding to the feature point on the overhead image BI (step S7). At this time, the control device 30 may also display the external environment information corresponding to the feature point (for example, the front image captured at the feature point).

Next, the control device 30 determines whether the designation of the movement completion point EP by the user is received (step S8). When it is determined that the designation of the movement completion point EP is received (step S8: YES), the control device 30 sets the point designated by the user as the movement completion point EP (step S9), and proceeds to processing in step S11.

When it is determined that the designation of the movement completion point EP is not received (step S8: NO), the control device 30 sets the default point as the movement completion point EP (step S10), and proceeds to the processing in step S11. As described above, the default point may be a point returned along the travel route Rt from the current position of the vehicle 1 by the maximum distance of the travel route Rt indicated by the travel history information 200, or may be a point returned along the travel route Rt from the current position of the vehicle 1 by any distance designated in advance by the user.

Next, as shown in FIG. 4, the control device 30 displays the movement completion point icon IEP corresponding to the set movement completion point EP on the overhead image BI (step S11).

Then, the control device 30 starts the reverse assist travel from the current position of the vehicle 1 to the set movement completion point EP based on the travel history information 200 stored in the storage unit 35 (step S12).

Next, the control device 30 determines whether the vehicle 1 reaches the movement completion point EP (step S13). When it is determined that the vehicle 1 does not reach the movement completion point EP (step S13: NO), the control device 30 ends the series of processing.

When it is determined that the vehicle 1 reaches the movement completion point EP (step S13: YES), the control device 30 ends the reverse assist travel (step S14) and ends the series of processing. When the reverse assist travel is ended, the control device 30 may notify the user that the reverse assist travel is completed. As an example, the control device 30 may notify the user that the reverse assist travel is completed, by displaying a message such as “the reverse assist is completed” on the touch panel 22.

As described above, according to the control device 30 of the present embodiment, since the reverse assist travel for moving the vehicle from the current position of the vehicle 1 to the movement completion point EP desired by the user can be performed, the convenience of the user is improved. Further, it is possible to improve traffic safety and contribute to development of a sustainable transportation system.

The travel history information 200 includes, for example, information in which the information indicating the position of the vehicle 1, control information (for example, the information indicating the steering angle θst) for the vehicle 1, and the external environment information around the vehicle 1 at the same time point during the manual driving travel are associated with each other. Therefore, the control device 30 can cause the vehicle 1 to appropriately travel to the movement completion point EP by the reverse assist based on the travel history information 200.

For example, before the reverse assist travel, the control device 30 displays, on the touch panel 22, the overhead image BI in which the travel route Rt is drawn from an overhead viewpoint. Then, in response to the movement completion point EP being set, the control device 30 displays the movement completion point icon IEP at or around the position corresponding to the movement completion point EP in the overhead image BI. Accordingly, it is possible to notify the user of the movement completion point EP being set and the set movement completion point EP in an intuitive and easily understandable manner.

Further, in response to the movement completion point EP being set, the control device 30 may display the external environment information corresponding to the movement completion point EP at or around the position corresponding to the movement completion point EP in the overhead image BI. In this way, it is possible to notify the user of what point the movement completion point EP is in an intuitive and easily understandable manner.

Further, the control device 30 may display the feature point icon at or around a position corresponding to a predetermined point (for example, the feature point) on the travel route Rt in the overhead image BI. In this way, it is possible to notify the user of the predetermined point that may be a candidate for the movement completion point EP in an intuitive and easily understandable manner.

The predetermined point may be a feature point such as an inflection point on the travel route Rt, a place where the road width changes, a place where the road width is a certain value or more, an intersection entrance, a dead end entrance, or a sign installation place. In this way, it is possible to notify the user of the feature point that tends to be designated by the user as the movement completion point EP.

### 3. Modification

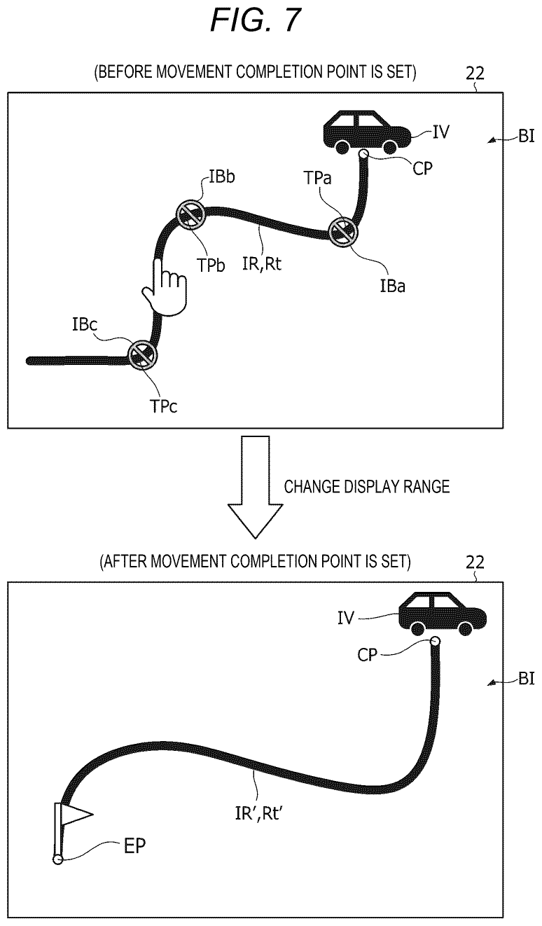

Next, a modification of the vehicle control performed by the control device 30 will be described with reference to FIG. 7. The present modification is an example in which the control device 30 (for example, the display control unit 31) changes a display range of the overhead image BI (in other words, a scale of the overhead image BI) in response to the movement completion point EP being set. In the following, portions different from the example described above will be mainly described, and the description of portions common to the example described above will be appropriately omitted or simplified.

For example, as shown in FIG. 7, before the movement completion point EP is set, the control device 30 (for example, the display control unit 31) may display the overhead image BI including the travel route image IR representing the entire travel route Rt (for example, the entire travel route Rt of a predetermined distance immediately before the vehicle 1 reaches the current position) indicated by the travel route information contained in the travel history information 200.

Then, in response to the movement completion point EP being set, the control device 30 may display the overhead image BI including a travel route image IR′ representing a travel route Rt′ that is a portion of the travel route Rt from the current position CP of the vehicle 1 to the movement completion point EP. Accordingly, a limited display area of the touch panel 22 can be effectively used to notify, in an easily understandable manner, the user of a portion from the current position CP of the vehicle 1 to the movement completion point EP, that is, a portion where the vehicle 1 performs the reverse assist travel.

As shown in FIG. 7, the control device 30 may not display the feature point icons IBa, IBb, and IBc in response to the movement completion point EP being set. This is because the feature point icons IBa, IBb, and IBc are information for assisting selection (designation) of the movement completion point EP by the user. For the same reason, when the landscape images LIa, LIb, and LIc are displayed as shown in FIG. 3, the control device 30 may not display the images in response to the movement completion point EP being set.

As described above, according to the present embodiment and the modification thereof, the convenience of the user can be improved. Further, it is possible to improve the traffic safety and contribute to the development of the sustainable transportation system.

Although various embodiments have been described above with reference to the drawings, it is needless to say that the present disclosure is not limited to these examples. It is apparent to those skilled in the art that various changes or modifications can be conceived within the scope described in the claims, and it is understood that the changes or modifications naturally fall within the technical scope of the present disclosure. In addition, the constituent elements in the above embodiment may be freely combined without departing from the gist of the disclosure.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the embodiment described above, the computer that executes the program is the control device 30 provided in the vehicle 1, but the present disclosure is not limited thereto. For example, the computer that executes the present program may be provided in another device (for example, the external device 2) capable of communicating with the control device 30.

In the present description, at least the following matters are described. In the parentheses, the corresponding constituent elements and the like in the above embodiment are shown as examples, but the present disclosure is not limited thereto.

(1) A control device (control device 30) for controlling a vehicle (vehicle 1), including:
a travel control unit (travel control unit 33) configured to perform, based on travel history information (travel history information 200) including travel route information indicating a travel route (travel route Rt) during first travel to a current position (current position CP) of the vehicle, second travel for causing the vehicle to move along the travel route from the current position to a movement completion point (movement completion point EP) on the travel route, the travel history information being stored in a storage unit (storage unit 35); and
a setting unit (setting unit 32) configured to set, before the second travel, any point on the travel route designated by a user as the movement completion point, in which
the travel control unit performs the second travel to the movement completion point set by the setting unit, and ends the second travel in response to the vehicle reaching the movement completion point.

According to (1), since the second travel for causing the vehicle to move from the current position of the vehicle to the movement completion point desired by the user can be performed, convenience of the user is improved. Further, it is possible to improve traffic safety and contribute to development of a sustainable transportation system.

(2) The control device according to (1), in which
the travel history information includes information in which information indicating a position of the vehicle, control information for the vehicle, and external environment information around the vehicle at a same time point during the first travel are associated with one another.

According to (2), it is possible to cause the vehicle to appropriately travel to the movement completion point by the second travel based on the travel history information.

(3) The control device according to (1) or (2), further including:
a display control unit (display control unit 31) configured to display, before the second travel, an overhead image (overhead image B1) in which the travel route is drawn from an overhead viewpoint on a display unit (touch panel 22) provided in the vehicle, in which
the display control unit displays a first icon (movement completion point icon IEP) at or around a position corresponding to the movement completion point in the overhead image in response to the movement completion point being set by the setting unit.

According to (3), it is possible to notify the user of the movement completion point being set and the set movement completion point EP in an intuitive and easily understandable manner.

(4) The control device according to (3), in which
the travel history information includes information in which information indicating a position of the vehicle, control information for the vehicle, and external environment information around the vehicle at a same time point during the first travel are associated with one another, and,
in response to the movement completion point being set by the setting unit, the display control unit displays the external environment information corresponding to the movement completion point at or around a position corresponding to the movement completion point in the overhead image.

According to (4), it is possible to notify the user of what point the movement completion point is in an intuitive and easily understandable manner.

(5) The control device according to (3), in which
the display control unit changes a display range of the overhead image in response to the movement completion point being set.

According to (5), a limited display area of the display unit can be effectively used to notify, in an easily understandable manner, the user of a portion from the current position to the movement completion point.

(6) The control device according to (5), in which
the display control unit
   displays the overhead image representing the entire travel route before the movement completion point is set, and
   displays the overhead image representing a portion of the travel route from the current position to the movement completion point in response to the movement completion point being set.

According to (6), the limited display area of the display unit can be effectively used to notify, in an easily understandable manner, the user of the portion from the current position to the movement completion point.

(7) The control device according to (2), further including:
a display control unit (display control unit 31) configured to display, before the second travel, an overhead image (overhead image BI), in which the travel route is drawn from an overhead viewpoint, on a display unit (touch panel 22) provided in the vehicle, in which
the display control unit displays a second icon (feature point icon Iba, IBb, IBc) at or around a position corresponding to a predetermined point (feature point TPa, TPb, TPc) on the travel route in the overhead image.

According to (7), it is possible to notify the user of the predetermined point that may be a candidate for the movement completion point in an intuitive and easily understandable manner.

(8) The control device according to (1) or (2), further including:
a display control unit (display control unit 31) configured to display, before the second travel, an overhead image (overhead image BI), in which the travel route is drawn from an overhead viewpoint, on a display unit (touch panel 22) provided in the vehicle, in which
the travel history information includes information in which information indicating a position of the vehicle, control information for the vehicle, and external environment information around the vehicle at the same time point during the first travel are associated with one another, and
the display control unit displays, at or around a position corresponding to a predetermined point (feature point TPa, TPb, TPc) on the travel route in the overhead image, the external environment information (landscape image Lia, Lib, LIc) corresponding to the predetermined point.

According to (8), it is possible to notify, in an intuitive and easily understandable manner, the user of what point the predetermined point that may be a candidate for the movement completion point is.

(9) The control device according to (7) or (8), in which
the predetermined point includes any one of an inflection point with a predetermined angle or more on the travel route, a place where a road width changes, a place where the road width is a predetermined value or more, an intersection entrance, a dead end entrance, or a sign installation place.

According to (9), it is possible to notify the user of the predetermined point that tends to be designated by the user as the movement completion point.

(10) A control method including:
Performing (step S10 to S12), by a computer (control device 30) that controls a vehicle (vehicle 1), based on travel history information (travel history information 200) including travel route information indicating a travel route (travel route Rt) during first travel to a current position (current position CP) of the vehicle, second travel for causing the vehicle to move along the travel route from the current position to a movement completion point (movement completion point EP) on the travel route, the travel history information being stored in a storage unit (storage unit 35); and
setting (step S9), by the computer, before the second travel, any point on the travel route designated by a user as the movement completion point, in which
in the processing of performing the second travel, the second travel to the set movement completion point is performed, and the second travel is ended in response to the vehicle reaching the movement completion point.

According to (10), since the second travel for causing the vehicle to move from the current position of the vehicle to the movement completion point desired by the user can be performed, the convenience of the user is improved. Further, it is possible to improve the traffic safety and contribute to the development of the sustainable transportation system.

(11) A non-transitory computer-readable storage medium storing a control program causing a computer (control device 30), that controls a vehicle (vehicle 1), to execute a process, the process including:
performing (step S10 to S12), based on travel history information (travel history information 200) including travel route information indicating a travel route (travel route Rt) during first travel to a current position (current position CP) of the vehicle, second travel for causing the vehicle to move along the travel route from the current position to a movement completion point (movement completion point EP) on the travel route, the travel history information being stored in a storage unit (storage unit 35); and
setting (step S9), before the second travel, any point on the travel route designated by a user as the movement completion point, in which
in the processing of performing the second travel, the second travel to the set movement completion point is performed, and the second travel is ended in response to the vehicle reaching the movement completion point.

According to (11), since the second travel for causing the vehicle to move from the current position of the vehicle to the movement completion point desired by the user can be performed, the convenience of the user is improved. Further, it is possible to improve the traffic safety and contribute to the development of the sustainable transportation system.

What is claimed is:

1. A control device for controlling a vehicle, comprising:
a travel control unit configured to perform, based on travel history information including travel route information indicating a travel route during first travel to a current position of the vehicle, second travel for causing the vehicle to move along the travel route from the current position to a movement completion point on the travel route, the travel history information being stored in a storage unit; and
a setting unit configured to set, before the second travel, any point on the travel route designated by a user as the movement completion point, wherein
the travel control unit performs the second travel to the movement completion point set by the setting unit, and ends the second travel in response to the vehicle reaching the movement completion point.

2. The control device according to claim 1, wherein
the travel history information includes information in which information indicating a position of the vehicle, control information for the vehicle, and external environment information around the vehicle at a same time point during the first travel are associated with one another.

3. The control device according to claim 1, further comprising:
a display control unit configured to display, before the second travel, an overhead image in which the travel route is drawn from an overhead viewpoint on a display unit provided in the vehicle, wherein
the display control unit displays a first icon at or around a position corresponding to the movement completion point in the overhead image in response to the movement completion point being set by the setting unit.

4. The control device according to claim 3, wherein
the travel history information includes information in which information indicating a position of the vehicle, control information for the vehicle, and external environment information around the vehicle at a same time point during the first travel are associated with one another, and,
in response to the movement completion point being set by the setting unit, the display control unit displays the external environment information corresponding to the movement completion point at or around a position corresponding to the movement completion point in the overhead image.

5. The control device according to claim 3, wherein
the display control unit changes a display range of the overhead image in response to the movement completion point being set.

6. The control device according to claim 5, wherein
the display control unit
displays the overhead image representing the entire travel route before the movement completion point is set, and
displays the overhead image representing a portion of the travel route from the current position to the movement completion point in response to the movement completion point being set.

7. The control device according to claim 1, further comprising:
a display control unit configured to display, before the second travel, an overhead image, in which the travel route is drawn from an overhead viewpoint, on a display unit provided in the vehicle, wherein
the display control unit displays a second icon at or around a position corresponding to a predetermined point on the travel route in the overhead image.

8. The control device according to claim 1, further comprising:
a display control unit configured to display, before the second travel, an overhead image, in which the travel route is drawn from an overhead viewpoint, on a display unit provided in the vehicle, wherein
the travel history information includes information in which information indicating a position of the vehicle, control information for the vehicle, and external environment information around the vehicle at the same time point during the first travel are associated with one another, and
the display control unit displays, at or around a position corresponding to a predetermined point on the travel route in the overhead image, the external environment information corresponding to the predetermined point.

9. The control device according to claim 7, wherein
the predetermined point includes any one of an inflection point with a predetermined angle or more on the travel route, a place where a road width changes, a place where the road width is a predetermined value or more, an intersection entrance, a dead end entrance, or a sign installation place.

10. A control method comprising:
performing, by a computer that controls a vehicle, based on travel history information including travel route information indicating a travel route during first travel to a current position of the vehicle, second travel for causing the vehicle to move along the travel route from the current position to a movement completion point on the travel route, the travel history information being stored in a storage unit; and
setting, by the computer, before the second travel, any point on the travel route designated by a user as the movement completion point, wherein
in the processing of performing the second travel, the second travel to the set movement completion point is performed, and the second travel is ended in response to the vehicle reaching the movement completion point.

11. A non-transitory computer-readable storage medium storing a control program causing a computer, that controls a vehicle, to execute a process, the process comprising:
performing, based on travel history information including travel route information indicating a travel route during first travel to a current position of the vehicle, second travel for causing the vehicle to move along the travel route from the current position to a movement completion point on the travel route, the travel history information being stored in a storage unit; and
setting, before the second travel, any point on the travel route designated by a user as the movement completion point, wherein
in the processing of performing the second travel, the second travel to the set movement completion point is performed, and the second travel is ended in response to the vehicle reaching the movement completion point.
